(19) United States
(12) Patent Application Publication
(10) Pub. No.: US 2026/0266128 A1
(43) Pub. Date: Sep. 10, 2026

(54) SECTIONAL DOOR WITH BACK-LIT LED PANEL

(71) Applicant: CORNELLCOOKSON, LLC, Mountain Top, PA (US)

(72) Inventors: Raymond Earl Howard, Las Vegas, NV (US); Alexander Alvarez Avila, Phoenix, AZ (US); Richard Ryan Severson Carroll, Loveland, OH (US); Andrey Vasiliyevich Melguy, Tempe, AZ (US); Robert Davis Sparks, Phoenix, AZ (US); Xin Cui, Tempe, AZ (US); Zhizhou Wu, Tempe, AZ (US); Siva Prasanth Davuluri, Mason, OH (US); Justin Michael Evans, Liberty Township, OH (US)

(73) Assignee: Clopay Corporation, Mason, OH (US)

(21) Appl. No.: 19/165,368

(22) PCT Filed: Mar. 21, 2023
(86) PCT No.: PCT/US2023/015768

§ 371 Date: Sep. 15, 2025

(51) Int. Cl. E06B 7/28; E05D 15/24; F21V 33/00; F21Y 115/10

(52) U.S. Cl. CPC E06B 7/28; E05D 15/24; F21V 33/006; E05Y 2400/822; E05Y 2800/106; E05Y 2900/106; F21Y 2115/10

(57) ABSTRACT

In example implementations, a back-lit light emitting diode (LED) panel for a panel of a sectional door is provided. The back-lit LED panel includes a frame comprising a back side, a top side, a bottom side, a left side, and a right side, at least one LED array coupled to the back side of the frame, and a diffuser coupled to the top side, the bottom side, the left side, and the right side of the frame to enclose the at least one LED array, wherein the back-lit LED panel is less than 2 inches thick to fit into an opening of the panel of the sectional door.

### BACKGROUND

Doors can be used for a variety of applications. For example, doors can be used as in residential locations or doors for bays and entrances to warehouses in commercial locations. Some doors may include sectional doors. One type of sectional door may be garage doors.

Sectional doors may be made from a plurality of individual sections that are mechanically coupled together. The size and number of sections may be determined based on a size of the opening of the garage or any other type of location with an opening. One or more of the sections may have a wheel or endlock that can fit into a track. The track may guide movement of each section of the sectional door while opening and closing. The sectional door can be opened and closed manually with the help of a loaded torsion spring or mechanically via a motor or garage door opener.

### BRIEF DESCRIPTION OF THE DRAWINGS

FIG. 1 illustrates a block diagram of an example sectional door with a back-lit light emitting diode (LED) panel of the present disclosure;

FIG. 2 illustrates an isometric view of an example panel of the sectional door with an opening for the back-lit LED panel of the present disclosure;

FIG. 3 illustrates an isometric exploded view of an example of the back-lit LED panel of the present disclosure;

FIG. 4 illustrates a front view of an example of the back-lit LED panel of the present disclosure;

FIG. 5 illustrates a cross-sectional top view of an example of the back-lit LED panel of the present disclosure;

FIG. 6 illustrates an example of a panel with the LEDs of the back-lit LED panel of the present disclosure activated; and

FIG. 7 illustrates an example of the panel with selective LEDs of the back-lit LED panel of the present disclosure activated.

### DETAILED DESCRIPTION

Examples described herein provide examples of a sectional door with back-lit light emitting diode (LED) panels. As discussed above, doors can be used for a variety of different applications. Some doors may be sectional doors, such as those used as garage doors.

Some sectional doors may have glass panels. However, these glass panels can be transparent and allow others to look into the garage. Some users may want more privacy.

The present disclosure provides back-lit LED panels. The back-lit LED panels may be a modular integrated electrical component of the sectional door. The back-lit LED panels may replace standard glass panels in the sectional door. When activated, the LED panels may diffuse light through the glass panel to provide an evenly distributed light that can provide more privacy, more light and/or more options for aesthetics via different colored lights, text, and/or images.

In addition, the light emitted by the back-lit LED panels may provide desired aesthetics. For example, the back-lit LED panel may include different colored LED lights. Thus, the back-lit LED panel may emit different colored lights or different colored light combinations with multiple panels throughout the year. Green and red lights may be emitted during the holiday season, orange lights may be emitted during Halloween, and so forth. The back-lit LED panel may also be controlled to activate certain LEDs to generate letters and/or words across a series of back-lit LED panels on a single panel or multiple panels of a sectional door. The back-lit LED panel may also provide sufficient light output to illuminate a driveway or outside area.

In addition, the back-lit LED panel may be continuously or intermittently powered by a constant power source. In other words, the power source is not a battery or a power source that requires recharging. The electrical wiring for the back-lit LED panel may be routed through the panels of the sectional door. As a result, the electrical wiring may be located away from the tracks. Routing the electrical wiring within the panels may prevent entanglement or obstructions that could cause the sectional door to malfunction or operate improperly.

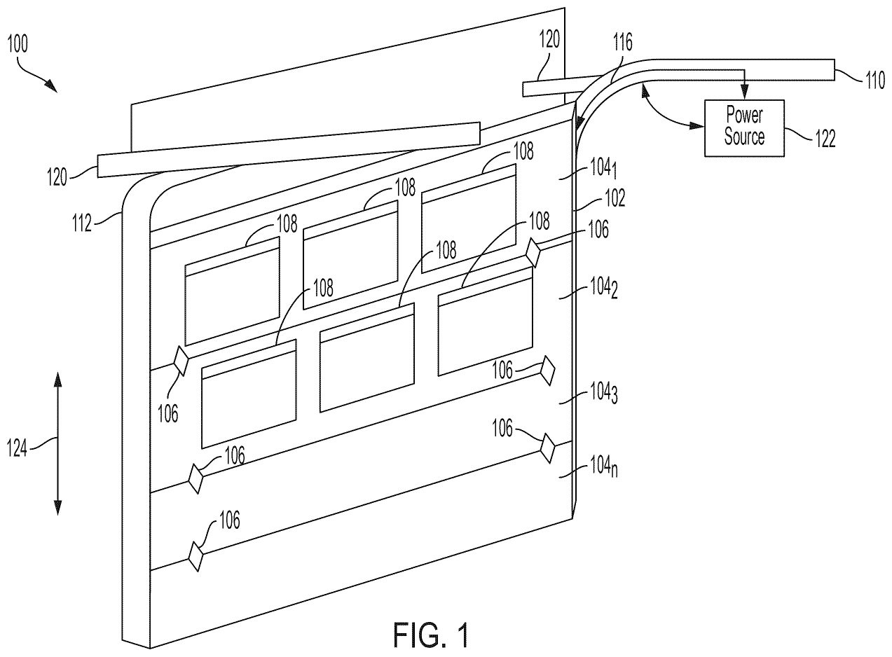

FIG. 1 illustrates a block diagram of a sectional door assembly 100 of the present disclosure. It should be noted that the sectional door assembly 100 in FIG. 1 has been simplified for ease of explanation. The sectional door assembly 100 may include additional features that are not shown. For example the sectional door 100 may include a rotating shaft, torsion springs, an operator, a user interface to control operation of the sectional door, one or more sensors, and the like.

In one embodiment, the sectional door assembly 100 may include a sectional door 102 that comprises a plurality of panels or sections 104₁ to 104ₙ (hereinafter also referred to individually as a panel 104 or collectively as panels 104). The panels may be movably connected to one another via mechanical hinges 106. The first panel 104₁ may be the top most panel 104 and the last panel 104ₙ may be the bottom most panel 104.

In one embodiment, some of the panels 104 may include an edge-lit LED panel 108 that requires continuous power. For example, panels 104₁ and 104₂ may have back-lit LED panels 108. In some examples, all of the panels 104 may include back-lit LED panels 108.

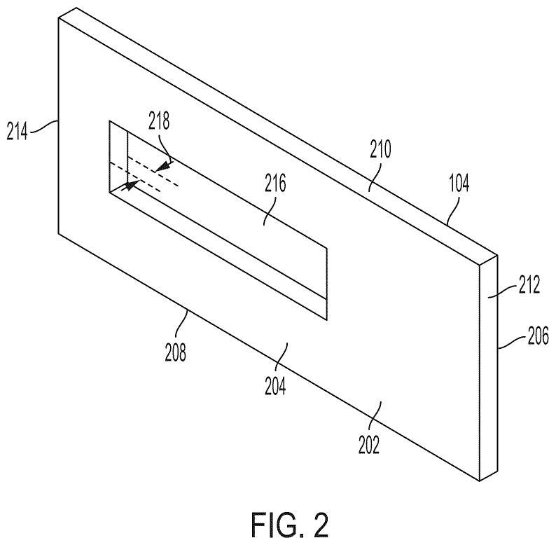

An electrical wire or cord 116 may be run from a constant power source 122 to the edge-lit LED panel 108. For example, the constant power source 122 may be always available to deliver power. In other words, the constant power source 122 is not a battery or does not need to be recharged. The constant power source 122 may provide continuous or intermittent power to the back-lit LED panel 108. The electrical wire 116 may be routed within the body of the panel 104 to keep the electrical wire 116 away from a path of the sectional door 102 within tracks 110 and 112. Further details of the back-lit LED panel 108 are illustrated in FIGS. 2-7 and discussed below.

The sectional door assembly 100 may include the tracks 110 and 112. The sectional door 102 may be guided by the tracks 110 and 112. The tracks 110 and 112 may be installed on opposite sides of the sectional door 102. A wheel (not shown) may be inserted into the tracks 110 and 112. In the case of a garage door, the garage door may have wheels that move within the tracks 110 and 112 as the garage door opens and closes in a direction as shown by an arrow 124.

The tracks 110 and 112 may be coupled to a wall of an opening where the sectional door 102 is installed. Horizontal angle brackets 120 may be coupled to a flag bracket (not shown) that is attached to the wall may further help to stabilize the tracks 110 and 112.

FIG. 2 illustrates an isometric view of an example panel 104 of the present disclosure. In one embodiment, the panel 104 may include a panel body 202. The panel body 202 may be fabricated from solid steel or may be assembled with composite or metal panels. The panel body 202 may have a front side 204, a back side 206, a bottom side 208, a top side 210, a right side 212, and a left side 214. The panel body 202 may include an interior volume where the electrical wire 116 may be routed to connect the back-lit LED panel 108 to the power source 122.

In one embodiment, the panel 104 may include an opening 216. The opening 216 may be a cut-out performed during manufacturing of the panel 104 or may be an opening formed by rails and stiles of the panel 104. The back-lit LED panel 108 may be inserted into the opening 216. In one embodiment, if the panel body 202 is solid, a tunnel or path may be bored into the panel body 202 to allow the electrical wire 116 to be routed through the panel body 202 to the back-lit LED panel 108.

In one embodiment, the opening 216 may have a thickness 218. The thickness 218 of the opening 216 may be approximately 1-4 inches. In one embodiment, opening 216 may have a thickness 218 of approximately 2 inches thick. Thus, the optical characteristics of the back-lit LED panel 108 may be designed to operate within the limited thickness of the opening 216. In some embodiments, the operating thickness for the back-lit LED panel 108 may be between 1-3 inches. In one embodiment, the operating thickness may be approximately 1 inch or less. This may be due to the design of the framing for the back-lit LED panel 108 and how the back-lit LED panel 108 may be installed into the opening 216.

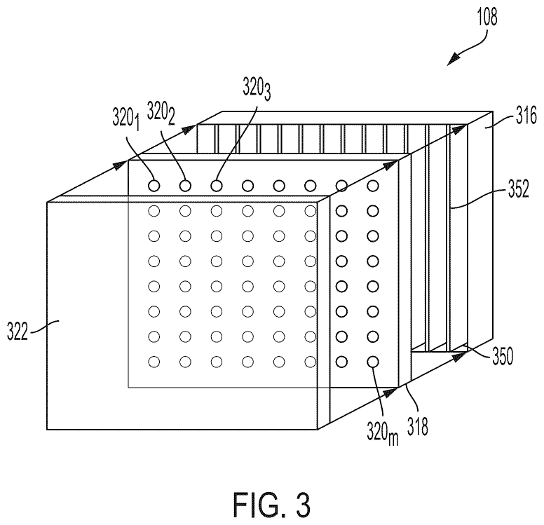

FIGS. 3-5 illustrate various views of the back-lit LED panel 108. FIG. 3 illustrates an isometric exploded view of an example back-lit LED panel 108. In one embodiment, the back-lit LED panel 108 may include a frame 316, an LED panel 318 including one or more LEDs 320₁-320ₘ (hereinafter also referred to individually as an LED 320 or collectively as LEDs 320), and a diffuser 322.

In one embodiment, the frame 316 may be fabricated from a metal or a laminated material including a combination of polymeric materials, wood, metals and combinations thereof. In one embodiment, the frame 316 may be fabricated with a flat back side 350. The LED panel 318 may rest against the flat back side 350.

In one embodiment, the frame 316 may include fins 352. The fins 352 may be fabricated from a metal. The fins 352 may act as a heat sink for the LEDs 320 and directly contact the backside of the LED panel 318. The fins 352 may increase an amount of surface area in the frame 316 to dissipate heat away from the LEDs 320.

In one embodiment, the LED panel 318 may be a printed circuit board (PCB). The LEDs 320 may be electrically coupled to the PCB. The electrical wire 116 from the power source 122 may be electrically connected to PCB or to a power source that powers the LEDs 320 on the PCB.

In one embodiment, the LEDs 320 may be any type of LED. For example, the LEDs may be gallium nitride (GaN) LEDs, aluminum gallium nitride (AlGaN) LEDs, indium gallium nitride (InGaN) LEDs, aluminum gallium phosphide (AlInGaP) LEDs, and the like. The LEDs 320 may be coated to achieve a desired color (e.g., phosphor coated LEDs).

In one embodiment, the LEDs 320 may all be the same color. In one embodiment, the LEDs 320 may all be a different color. In one embodiment, the LEDs 320 may be arranged in arrays or rows. Each row may be the same color, but different rows may have different colors.

In one embodiment, each LED 320 may be independently controllable. For example, each LED 320 may be controlled to turn on and off independent of the other LEDs 320 on the LED panel 318.

In one embodiment, the diffuser 322 may be fabricated from glass. As used herein, glass means a transparent or translucent material that may be a silicate material or a polymeric material such as an acrylic polymer or carbonate polymer. For example, the diffuser 322 may be fabricated from optically clear polymeric materials such as polycarbonate or polyarcylates. In another example, the diffuser 322 may be an opal diffuser that is frosted. The diffuser 322 may include a surface that provides reflection or light scattering in a desired direction. For example, the diffuser 322 may include a surface that is a total internal reflection (TIR) surface, a light scattering strip, and the like. In one embodiment, the diffuser 322 may include a pattern of micro-prisms or a honeycomb texture to scatter light into a desired light distribution pattern.

The diffuser 322 may spread the light emitted from the LEDs 320 evenly such that the diffuser 322 creates a Lambertian light profile or a batwing light profile. The diffuser 322 may also prevent hot spots from being visible. In other words, the diffuser 322 may prevent a user from seeing point sources or the individual LEDs 320 below the diffuser 322.

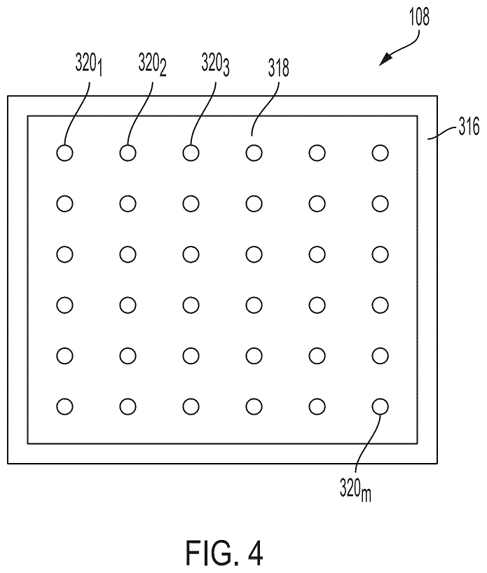

FIG. 4 illustrates a front view of the back-lit LED panel 108. FIG. 4 illustrates the frame 316, the LED panel 318, and the LEDs 320. Although the back-lit LED panel 108 is shown in a particular shape, it should be noted that the back-lit LED panel 108 may be fabricated to be any shape (e.g., oval, circle, square, diamond, triangle, trapezoid, polygon, and the like) to match the shape of the opening 216.

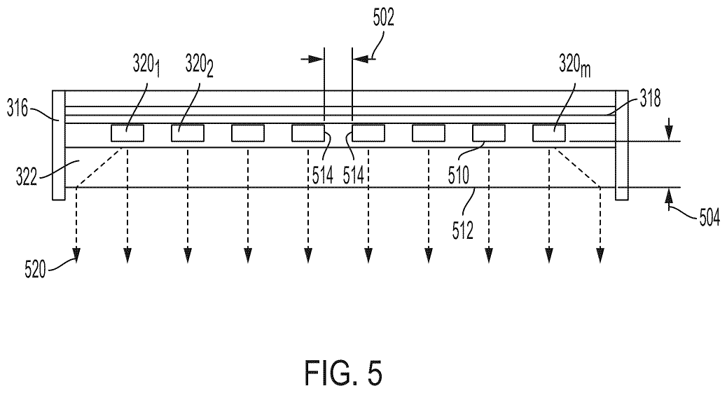

FIG. 5 illustrates a cross-sectional top view of an example of the back-lit LED panel 108. The LEDs 320 may emit light in a hemispherical pattern and emit light through the diffuser 322, as shown by the arrows 520.

As discussed above, the back-lit LED panel 108 may be designed to work within a thickness 218 of the opening 216. The thickness 218 may be between 1-4 inches or approximately 2 inches. Moreover, due to the size of the frame 316, the operating thickness of the LED panel 318, the LEDs 320, and the diffuser 322 may be between 1-3 inches or approximately 1 inch +/−0.5 inches.

When the diffuser 322 is too close to the LEDs 320, the diffuser 322 may not operate properly. For example, the LEDs 320 may be visible through the diffuser 322 and appear to have hot spots or visible circles through the diffuser 322.

One solution may be to add a high density of LEDs 320 on the LED panel 318. However, the back-lit LED panel 108 of the present disclosure is also designed to work as a Class 2 or Class 4 device in accordance with the National Electric Code (NEC). NEC Class 2 circuits should only be connected to a power supply with a load side that has a rating of less than 100 volt amps (VA) and a voltage of up to 30 V.

NEC Class 4 power systems mainly use direct current (DC) power. DC power is only made up of active power, which is why Watts are used to measure power instead of VA (apparent power). Class 2 power systems also mainly use DC power. The design of the back-lit LED panels 108 of the present disclosure should be able to be limited to 100 Watts of current in Class 4 power systems in the span of 5 seconds after any fault condition. Thus, having large number of LEDs 320 or a high density of LEDs 320 may cause the back-lit LED panel 108 to fail to meet the requirements of NEC Class 2 or Class 4.

Thus, for the diffuser 322 to operate properly, a distance 504 between a top most surface 510 of the LEDs 320 and an outer surface 512 of the diffuser 322 should be approximately two times (2×) a distance 502 between the adjacent sides 514 of the LED 320. This relationship between the distance 504 and the distance 502 may define the LED density (e.g., the LEDs 320 per area of the LED panel 318) given the space constraints (approximately 1 inch or less than 2 inches).

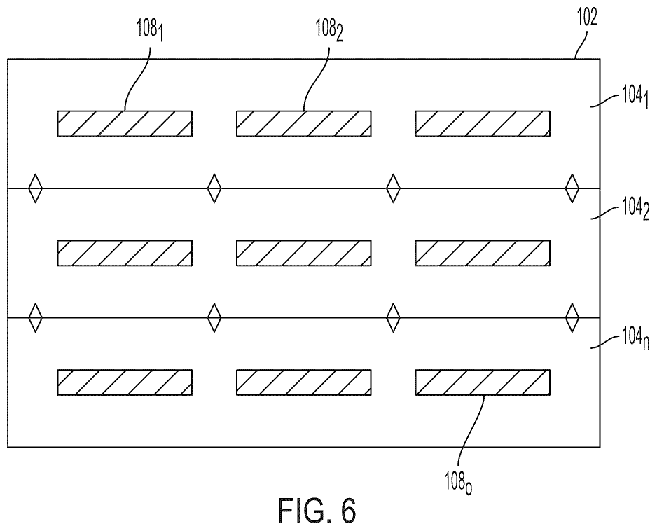

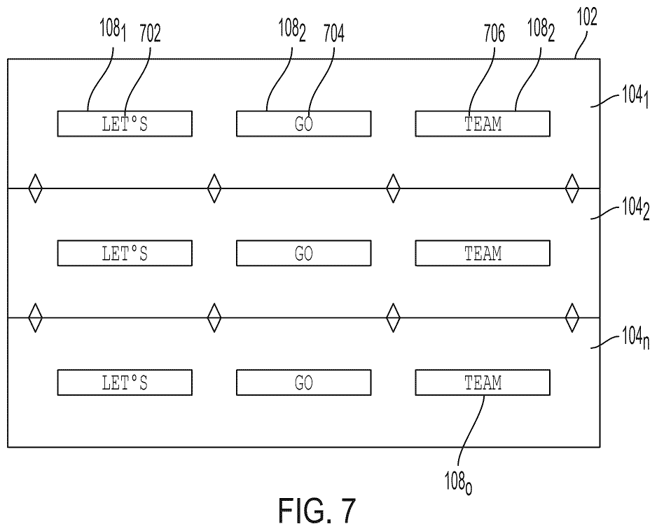

FIGS. 6 and 7 illustrate different examples of the back-lit LED panel 108 activated in the sectional door 102. FIG. 6 illustrates an example where all of the LEDs 320 are activated in the back-lit LED panel 108. When all of the LEDs 320 are activated, the back-lit LED panel 108 may emit a solid even colored light, as shown by greyed out boxes in FIG. 6.

As noted above, the back-lit LED panel 108 may include different colored LEDs 320 or the same colored LEDs (e.g., red, green, blue LEDs). In one embodiment, by using different colored LEDs 320 different colors may be generated by the back-lit LED panel 108. Thus, different back-lit LED panels 108 of the plurality of back-lit LED panels 108₁ to 108ₒ may emit different colors. For example, back-lit LED panel 108₁ may emit a green color and the back-lit LED panel 108₂ may emit a red color.

FIG. 7 illustrates an example where selective LEDs 320 within each LED panel 318 are activated. In one embodiment, each LED 320 may be independently controllable as described above. In one embodiment, selective LEDs 320 may be activated to generate desired text or a desired image/pattern. FIG. 7 illustrates how each back-lit LED panel 108 may display different text. For example, the back-lit LED panel 108₁ may display text 702 (e.g., LET'S), the back-lit LED panel 108₂ may display text 704 (e.g., GO), and the back-lit LED panel 108₃ may display text 706 (e.g., TEAM).

In one embodiment, the diffuser 322 may include an electrically activated diffuser (e.g., an electrically activated film). As noted above, the diffuser 322 may spread the light evenly so that the individually LEDs 320 cannot be seen. However, when generating text or an image, it may be desirable to see each LED 320. Thus, the diffuser 322 may be deactivated to allow the individual LEDs 320 to be seen to display the texts 702, 704, and 706.

Thus, the present disclosure provides sectional doors with a back-lit LED panel. The back-lit LED panel may be installed as part of the fabrication of the sectional door. The back-lit LED panel can receive continuous or intermittent power and wired in a way to prevent the wires from getting tangled or potentially interfering with the operation of the sectional door. The back-lit LED panel may also generate desired colors of light, desired text, and/or a desired pattern/image when activated, as described above.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A back-lit light emitting diode (LED) panel for a panel of a sectional door, comprising:
a frame comprising a back side, a top side, a bottom side, a left side, and a right side;
at least one LED array coupled to the back side of the frame; and
a diffuser coupled to the top side, the bottom side, the left side, and the right side of the frame to enclose the at least one LED array, wherein the back-lit LED panel is less than 2 inches thick to fit into an opening of the panel of the sectional door.

2. The back-lit LED panel of claim 1, wherein the back-lit LED panel has a thickness of approximately 1 inch.

3. The back-lit LED panel of claim 1, wherein a distance between a top most point of the at least one LED array to an outer surface of the diffuser is two times a distance between each LED of the at least one LED array.

4. The back-lit LED panel of claim 1, wherein the at least one LED array comprises different colored LEDs.

5. The back-lit LED panel of claim 1, wherein the diffuser comprises an opal diffuser.

6. The back-lit LED panel of claim 1, wherein the at least one LED array is activated to generate a text or an image.

7. A panel of a sectional door, comprising:
a panel housing;
an opening in the panel housing;
an back-lit light emitting diode (LED) panel in the opening; and
a constant power source electrically connected to the back-lit LED panel.

8. The panel of claim 7, wherein the panel housing is fabricated from steel.

9. The panel of claim 7, wherein a thickness of the opening is less than 2 inches.

10. The panel of claim 7, wherein the back-lit LED panel comprises:
a frame comprising a back side, a top side, a bottom side, a left side, and a right side;
an LED array coupled to the back side of the frame; and
a diffuser coupled to the frame to enclose the LED array.

11. The panel of claim 10, wherein the back-lit LED panel has a thickness of approximately 1 inch.

12. The panel of claim 10, wherein a distance between a top most point of the LED array to an outer surface of the diffuser is two times a distance between each LED of the LED array.

13. The panel of claim 10, wherein the LED array comprises different colored LEDs.

14. The panel of claim 10, wherein the diffuser comprises an opal diffuser.

15. The panel of claim 10, wherein the diffuser comprises a flat diffuser with a micro-prism texture or a honeycomb texture.

16. The panel of claim 7, wherein the panel comprises a plurality of openings in the panel housing and each one of the plurality of openings includes a back-lit LED panel.

17. The panel of claim 7, further comprising:
electrical wiring to connect the constant power source to the back-lit LED panel, wherein the electrical wiring is routed within a body of the panel housing.

18. A sectional door assembly, comprising:
a first track and a second track;
a sectional door comprising a plurality of panels, wherein the sectional door is movably coupled into the first track and the second track, wherein the first track and the second track guide a movement of the sectional door, wherein the plurality of panels includes at least one opening;
a back-lit light emitting diode (LED) panel located in the at least one opening; and
a constant power source electrically connected to the back-lit LED panel.

19. The sectional door assembly of claim 18, wherein a thickness of the at least one opening is less than 2 inches.

20. The sectional door assembly of claim 18, wherein the back-lit LED panel comprises:
a frame comprising a back side, a top side, a bottom side, a left side, and a right side;
an LED array coupled to the back side of the frame; and
a diffuser coupled to the frame to enclose the LED array.
